(19) United States
(12) Patent Application Publication
(10) Pub. No.: US 2014/0319819 A1
(43) Pub. Date: Oct. 30, 2014

(54) OPTICAL SECURITY DEVICE WITH NANOPARTICLE INK

(71) Applicant: Innovia Security Pty Ltd, Craigieburn, Victoria (AU)

(72) Inventors: Gary Fairless Power, Craigieburn (AU); Odisea Batistatos, Craigieburn (AU); Phei Lok, Craigieburn (AU); Michael Bruce Hardwick, Craigieburn (AU)

(73) Assignee: INNOVIA SECURITY PTY LTD, Craigiebum, Victoria (AU)

(21) Appl. No.: 14/367,675

(22) PCT Filed: Dec. 13, 2012
(86) PCT No.: PCT/AU2012/001520

§ 371 Date: Jun. 20, 2014

(30) Foreign Application Priority Data
Dec. 22, 2011 (AU) 2011101684

(51) Int. Cl. B42D 15/00

(52) U.S. Cl. CPC B42D 15/0013; B42D 2031/02
USPC 283/85; 427/7

(57) ABSTRACT

An optical security device, including a substrate (102) having a first surface and a second surface; and a metallic nanoparticle ink (104) provided intermittently in at least one area on the first surface (102) to produce a reflective or partially reflective patch or patches; wherein a high refractive index coating (106) is applied over the area or areas (108) in which the metallic nanoparticle ink is provided, the high refractive index coating (106) adhering to the first surface (102) where the metallic nanoparticle ink is not present, thereby retaining the metallic nanoparticle ink (104) between the first surface (102) and the high refractive index coating (106).

### FIELD OF THE INVENTION

This invention relates to optical security devices and methods for their manufacture. More particularly, it relates to optical security devices which utilise a nanoparticle ink in their construction.

### BACKGROUND TO THE INVENTION

Optical security devices are commonly used in security documents as a means of avoiding unauthorised duplication or forgery of such documents. Typically, such a device will produce an optical effect which is difficult for a potential counterfeiter to replicate.

A wide range of optical security devices are known in the art. Frequently, such devices rely upon the application of a reflective coating or a semitransparent coating with a high refractive index in order to display the optical effect. For example, it is common for an optical security device to be constructed by embossing a diffraction pattern into a polymer layer to form a surface relief pattern, and providing a thin reflective metal layer over the pattern. In this manner, the effect created by the diffraction pattern is viewable in reflection. Alternatively, the metal layer is substituted for a transparent layer with a high refractive index, allowing the diffractive effect to be viewed but also allowing any information behind the device to be visible.

The thin metal reflective layer may be provided in a number of ways. One way is to use a vacuum deposition process. In this process, the material to be coated is placed in a vacuum, and the metal is vaporised. When the vaporised metal contacts the material, it condenses and forms a metallic layer on the material. This procedure is effective in providing a reflective layer, however is relatively costly.

An alternative to the vacuum deposition process is to utilise a metallic nanoparticle ink to coat the required surface. The application of such an ink may be achieved at a substantially reduced cost compared to the vacuum deposition process, while still providing a thin coating that may either be highly reflective, or semitransparent with a high refractive index depending on the composition of the ink.

The use of metallic nanoparticle inks has previously been problematic, as such inks display weak adhesion to the surfaces to which they are applied. Consequently, despite the attractive optical properties of these inks, it has proved difficult to effectively use these types of inks in producing optical security devices.

It is therefore desirable to provide an optical security device utilising metallic nanoparticle inks that addresses the difficulties presented by the poor adhesion of such inks. It is also desirable to provide a method for manufacturing such optical security devices.

### SUMMARY OF THE INVENTION

According to one aspect of the invention, there is provided an optical security device, including a substrate having a first surface and a second surface; and a metallic nanoparticle ink provided intermittently in at least one area on the first surface to produce a reflective or partially reflective patch or patches; wherein a high refractive index coating is applied over the area or areas in which the metallic nanoparticle ink is provided, the high refractive index coating adhering to the first surface where the metallic nanoparticle ink is not present, thereby retaining the metallic nanoparticle ink between the first surface and the high refractive index coating, and wherein the reflective or partially reflective patch or patches at least partly overlies a diffractive relief structure.

The diffractive relief structure may be provided on the first surface of the substrate. Alternatively, the diffractive relief structure may be provided on the second surface of the substrate. The relief structure may be a diffractive optical element.

A transparent or translucent coating may applied directly to at least part of the or each relief structure where the reflective or partially reflective patch or patches are not present. The refractive index of the transparent or translucent coating may be substantially the same as the refractive index of the or each relief structure.

Preferably, the high refractive index coating and the transparent or translucent coating may have the same refractive index. Even more preferably, the coatings may be the same, preferably applied at the same time.

This allows that the parts of the relief structure not provided with metallic nanoparticle ink may be made invisible as necessary.

Alternatively, the relief structure may be q high-resolution or high aspect ratio grating such as a polarisation grating.

The metallic nanoparticle ink may be provided in a plurality of substantially parallel lines on the first surface. Where the metallic nanoparticle ink is provided in this manner, preferably each line has a width of 1 nm to 200 μm, and further preferably, the lines are spaced apart by 1 nm to 200 μm.

Alternatively, the metallic nanoparticle ink is provided in a plurality of substantially circular spots. Where the metallic nanoparticle ink is provided in this manner, preferably each substantially circular spot has a diameter of 1 nm to 200 μm, and further preferably the spots are spaced apart by 1 nm to 200 μm.

Preferably the size and spacing of the substantially parallel lines or substantially circular spots produces an optical density of greater than 0.1.

The coating may be a curable coating.

The metallic nanoparticle ink may form a substantially opaque, reflective layer. Alternatively the metallic nanoparticle ink may form a semitransparent layer with a refractive index greater than that of the relief structure.

The metallic nanoparticle ink may be a silver nanoparticle ink. Where this is the case, the silver nanoparticle ink preferably has less than 40% silver.

Alternatively, the metallic nanoparticle ink may be an aluminium nanoparticle ink. Further alternatively the metallic nanoparticle ink is a titanium nanoparticle ink.

The substrate of the optical security device may be transparent or translucent. The optical security device may include at least one opacifying layer applied to at least part of the first surface of the transparent or translucent substrate. Further, the optical security device may include at least one opacifying layer applied to at least part of the second surface of the transparent or translucent substrate.

Preferably, the at least one opacifying layer is at least partly omitted to form a window or half window on at least one of the first and second surface of the substrate in the area where the metallic nanoparticle ink and high refractive index coating are provided.

Even more preferably, at least one of the opacifying layers is provided intermittently to the second surface of the substrate in the region of the metallic nanoparticle ink to form indicia or an image.

The at least one opacifying layer is an opacifying coating, preferably an opacifying ink layer.

According to a further aspect of the invention, there is provided a method of manufacturing an optical security device, including applying a metallic nanoparticle ink intermittently in at least one area on a first surface of a substrate, and applying a high refractive index coating over the or each area in which the metallic nanoparticle ink has been applied, whereby the high refractive index coating adheres to the first surface where the metallic nanoparticle ink is not present, thereby retaining the metallic nanoparticle ink between the first surface and the high refractive index coating, and further including the step of providing a diffractive relief structure on the first or second surface of the substrate prior to applying the metallic nanoparticle ink.

The relief structure may be provided as a diffractive optical element.

The method may also include the step of applying a transparent or translucent coating directly to at least part of the or each relief structure where the reflective or partially reflective patch or patches are not present, and wherein the refractive index of the transparent or translucent coating is substantially the same as the refractive index of the or each relief structure.

Preferably, the high refractive index coating and the transparent or translucent coating may have the same refractive index. Even more preferably, the coatings may be applied at the same time.

Alternatively, the relief structure may be provided as a q high-resolution or high aspect ratio grating such as a polarisation grating.

The metallic nanoparticle ink may be applied in a plurality of substantially parallel lines on the first surface. Where the metallic nanoparticle ink is applied in this manner, preferably each line has a width of 1 nm to 200 μm, and further preferably, the lines are spaced apart by 1 nm to 200 μm.

Alternatively, the method includes that the metallic nanoparticle ink is applied in a plurality of substantially circular spots. Where the metallic nanoparticle ink is provided in this manner, preferably each substantially circular spot has a diameter of 1 nm to 200 μm, and further preferably the spots are spaced apart by 1 nm to 200 μm.

Preferably the size and spacing of the substantially parallel lines or substantially circular spots produces an optical density of greater than 0.1.

The coating may be applied as a curable coating.

The method may include the step of applying the metallic nanoparticle ink as a substantially opaque, reflective layer. Alternatively the metallic nanoparticle ink may be applied a semitransparent layer with a refractive index greater than that of the relief structure.

The metallic nanoparticle ink may be applied as a silver nanoparticle ink. Where this is the case, the silver nanoparticle ink preferably has less than 40% silver.

Alternatively, the method may include applying an aluminium nanoparticle ink or a titanium nanoparticle ink.

The method may include providing a transparent or translucent substrate.

The method may further include applying at least one opacifying layer applied to at least part of the first surface of the transparent or translucent substrate. Further, the method may include at least one opacifying layer applied to at least part of the second surface of the transparent or translucent substrate.

An additional step of the method may include the at least one opacifying layer is at least partly omitted to form a window or half window on at least one of the first and second surface of the substrate in the area where the metallic nanoparticle ink and high refractive index coating are provided. The method may also include applying the at least one of the opacifying layers is provided intermittently to the second surface of the substrate in the region of the metallic nanoparticle ink to form indicia or an image.

The method also includes the step of providing at least one opacifying layer is an opacifying coating, preferably an opacifying ink layer.

Further aspects of the invention are directed to a security document, such as a banknote including the optical security device as described in any of the embodiments.

### BRIEF DESCRIPTION OF THE DRAWINGS

Specific embodiments of the invention will now be described, by way of example only, and with reference to the accompanying drawings in which:

FIG. 1 is a representative cross section of an optical security device according to a first embodiment of the invention.

FIG. 2 is a representative cross section of an optical security device according to an alternative embodiment of the invention.

FIG. 3 is a representative cross section of an optical security device according to a further embodiment of the invention.

FIGS. 4a and 4b show representative cross sections of an optical security device according to another embodiment of the invention.

FIGS. 5a and 5b show representative cross sections of an optical security device according to yet another embodiment of the invention.

### DESCRIPTION OF PREFERRED EMBODIMENTS

### Definitions

### Security Document

As used herein, the term security document includes all types of documents and tokens of value and identification documents including, but not limited to the following: items of currency such as banknotes and coins, credit cards, cheques, passports, identity cards, securities and share certificates, driver's licences, deeds of title, travel documents such as airline and train tickets, entrance cards and tickets, birth, death and marriage certificates, and academic transcripts.

### Metallic Nanoparticle Ink

As used herein, the term metallic nanoparticle ink refers to an ink having metallic particles of an average size of less than one micron.

### Diffractive Optical Elements (DOEs)

As used herein, the term diffractive optical element refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

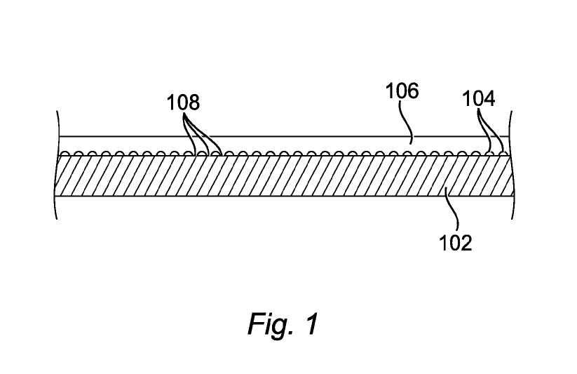

Referring to FIG. 1, there is shown a cross section of an optical security device, where a metallic nanoparticle ink 104 is provided intermittently in an area of the first surface of a substrate 102. A coating 106 is applied over the area in which the metallic nanoparticle ink 104 is provided. The coating 106 adheres to the surface of the substrate 102 in the areas 108 between the regions of metallic nanoparticle ink 104 where the metallic nanoparticle ink 104 is not present. In this manner the individual regions of metallic nanoparticle ink 104 are retained in position between the surface of the substrate 102 and the coating 106 despite the weak adhesion of the metallic nanoparticle ink 104 to the surface of the substrate 102.

The regions of metallic nanoparticle ink 104 together produce a reflective or partially reflective patch on the substrate 102. Multiple areas of a substrate may be provided with metallic nanoparticle ink in this manner if multiple reflective patches or partially reflective patches are desired.

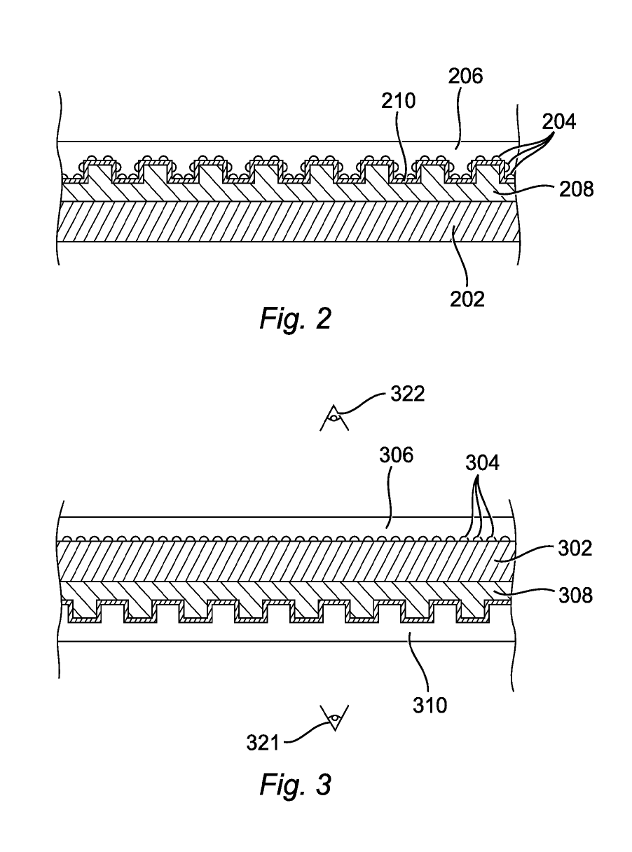

In an alternative embodiment of the invention, the metallic nanoparticle ink may be used to apply a thin reflective coating to a relief structure, such as a diffractive structure. Such an arrangement is shown in FIG. 2, in which a diffractive structure 208 is provided on the first surface of a substrate 202. The diffractive structure 208 may be integral with the substrate, for example being embossed into a polymer substrate, or alternatively may be applied as a separate element, for example by being embossed into a layer or coating applied to the substrate.

A metallic nanoparticle ink 204 is provided intermittently in an area of the diffractive structure 208. A coating 206 is applied over the area in which the metallic nanoparticle ink 204 is provided. Preferably, the coating 206 is a high refractive index (HRI) coating, as this will assist in ensuring that the optical effect produced by the diffractive structure 208 remains visible even the metallic nanoparticle ink 204 is applied in a very thin layer. The coating 206 adheres to the diffractive structure 208 in the areas 210 between the regions of metallic nanoparticle ink 204 where the metallic nanoparticle ink 204 is not present. In this manner, a reflective patch or patches may be provided over the diffractive structure. Where this patch forms a substantially opaque reflective layer, the diffractive effect produced by the diffractive structure may be viewed in reflection in the area where the patch or patches are provided.

Alternatively, as shown in FIG. 3, a diffractive structure may be provided on the opposite side of the substrate to metallic nanoparticle ink. Here, the metallic nanoparticle ink 304 and coating 306 are provided on the first side of the substrate, with a diffractive structure 308 provided on the second side of the substrate 302. A protective varnish 310 may be applied to the diffractive structure 308. The protective varnish 310 in this case should be a high refractive index coating (having a refractive index different from the substrate 302 by at least 0.2), otherwise the diffractive structure 308 will not be clearly visible. In this arrangement, it is preferable that at least part of the substrate 302 and diffractive structure 308 are transparent, and the patch formed by the metallic nanoparticle ink is a semi-transparent layer with a refractive index greater than that of the substrate and the diffractive structure. In this manner, the diffractive effect produced by the diffractive structure 308 may be viewed in transmission by a viewer positioned at 322 whilst being visible in reflection by a viewer positioned at 321. This result is possible as the use of the nanoparticle ink may provide a highly reflective surface, but also permits enough light through to allow the diffractive effect to be visible in transmission. Furthermore, nanoparticle inks give reflectivity which is equivalent to that achieved by vacuum metallisation, but can be provided more cheaply and efficiently as the ink is applied by a printing method.

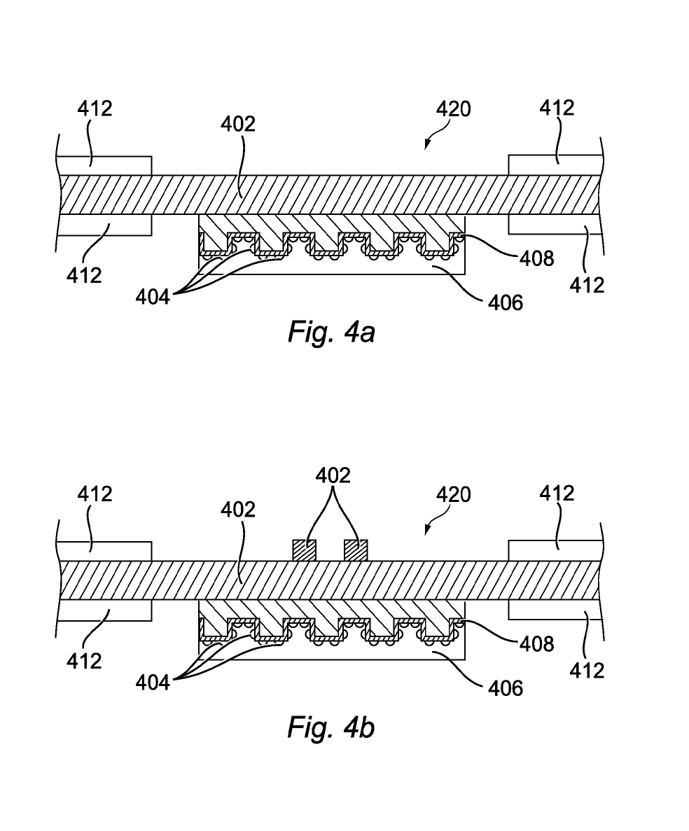

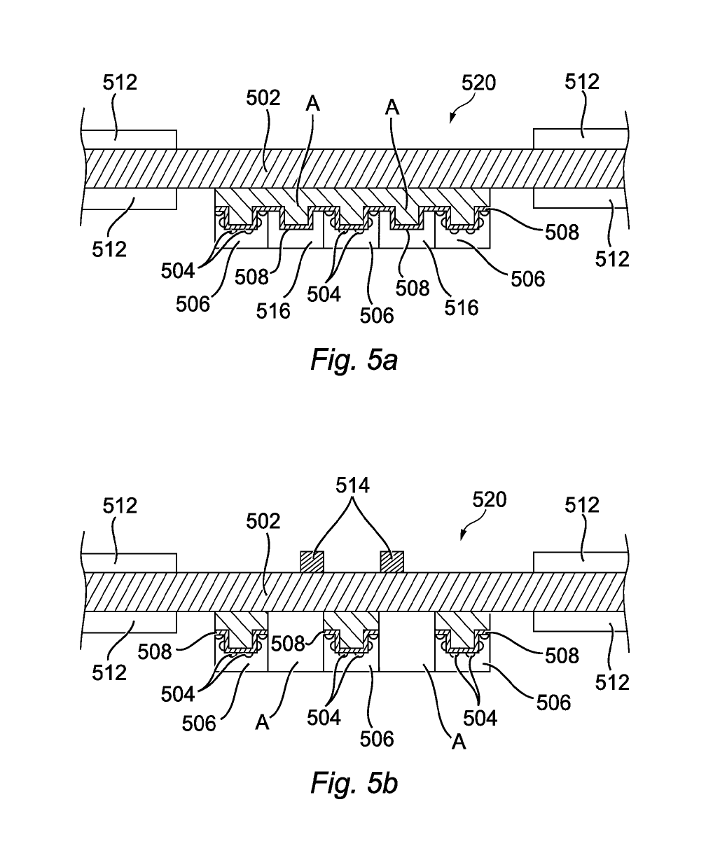

FIGS. 4a, 4b, 5a and 5b show cross sectional views of further embodiments of an optical security device where relief structures 408, 508 are provided on a first surface of a transparent or translucent substrate 402, 502. The substrate 402, 502 may be formed of a bi-axially oriented polypropylene (BOPP), or any other polymer material as known in the art. The relief structures 408, 508 may be formed integrally with the substrate 402, 502, such as by an embossing process or may be applied as a separate element, for instance by being embossed into a layer or coating applied to the substrate.

Metallic nanoparticle ink 404, 504 is applied intermittently to form one or more reflective patch or patches to overlay the relief structures 408, 508. A coating 406, 506 is applied over the area in which the metallic nanoparticle ink 404 is provided. Preferably, the coating 406, 506 is a high refractive index (HRI) coating, as this will assist in ensuring that the optical effect produced by the diffractive structure 408, 508 remains visible even the metallic nanoparticle ink 404, 504 is applied in a very thin layer. The coating 406, 506 adheres to the diffractive structure 408, 508 in the areas between the regions of metallic nanoparticle ink 404, 504 where the metallic nanoparticle ink 404, 504 is not present. In this manner, a reflective patch or patches may be provided over the diffractive structure 408, 508. Where this patch forms a substantially opaque reflective layer, the diffractive effect produced by the diffractive structure may be viewed in reflection in the area where the patch or patches are provided.

The optical security device of FIGS. 4a, 4b, 5a and 5b may act as a reflective and/or transmissive device depending on whether the reflective surface 404, 504, is a substantially opaque reflective layer or at least partially transmissive layer.

In FIGS. 5a and 5b, only parts of the diffractive structure 508 are provided with metallic nanoparticle ink 504. Areas A have not been applied with metallic nanoparticle ink 504. FIGS. 5a, 5b show that a HRI coating 506 has been applied to the parts of the the diffractive structure 508 which have been applied with metallic nanoparticle ink. In addition, a transparent or translucent coating 516 has been applied to parts of the diffractive structure, areas A, which do not have metallic nanoparticle ink 508.

FIG. 5b shows the effect if the transparent or translucent coating 514 has a refractive index substantially the same as the refractive index of the diffractive structure 508. This renders the diffractive structure 508 in those areas A, effectively invisible, and only the parts of the diffractive structure covered with metallic nanoparticle ink are visible. In a further embodiment, the coatings 506 and 514 may be applied in a single step as the same coating.

Opacifying layers 412, 512 may be applied to the first and/or second surfaces of the transparent or translucent substrate 402, 502, forming a window or half window 420, 520 where the optical security device may be viewed from one or more sides of the substrate 402, 502. The window or half-window may be part of a security document, such as a banknote. FIGS. 4a to 5b show the optical devices in a full window configuration. Further areas of opacifying layers 414, 514 may form one or more images or indicia on the second surface of the substrate 402, 502, opposite to the relief structures 408, 508. The opacifying layers 412, 414, 512 or 514 are preferably opacifying coatings, such as opacifying inks, which may be applied by a printing process, such as gravure, intaglio, flexography, screen printing or other suitable techniques as known in the art.

Referring to both FIGS. 2 and 3, the diffractive structure 208 or 308 could readily be replaced by any desired relief structure such as for example a diffractive optical element. Alternatively, high-resolution or high aspect ratio gratings such as polarisation gratings could be used, in which case nanoparticles less than 100 nm should be utilised.

In one embodiment of the invention, the metallic nanoparticle ink is a silver nanoparticle, having less than 40% silver. However, a range of other metallic nanoparticle inks will also be suitable for use in accordance with the invention, for example, silver nanoparticle inks with greater then 40% silver, aluminium nanoparticle inks and titanium nanoparticle inks.

It will be appreciated that a suitable coating should demonstrate one or all of the following attributes: good adhesion to the substrate, highly transparent, generally colourless, and robust. Possible coatings may include a transparent, non-high refractive varnish. By varnish it is meant a material that results in a durable protective finish. Exemplary transparent varnishes may include, but are not limited to, nitrocellulose and cellulose acetyl butyrate. Alternatively, the coating may be a high refractive index coating, being a coating having a metal oxide component of small particle size and high refractive index dispersed in a carrier, binder or resin. Such a high refractive index coating contains solvent as it is a dispersion. Where a high refractive index coating of this type is used, it may be air cured or UV cured. Alternatively, a high refractive index coating utilising a non-metallic polymer, such as sulfur-containing or brominated organic polymers may also be used.

The metallic nanoparticle ink is preferably applied to the surface of the substrate in either a plurality of substantially parallel lines, or a plurality of substantially circular spots. If the metallic nanoparticle ink is provided in a plurality of substantially parallel lines, the lines preferably have a width of 1 nm to 200 μm, and preferably spaced apart by 1 nm to 200 μm. If the metallic nanoparticle ink is provided in a plurality of substantially circular spots, the spots preferably have a diameter of 1 nm to 200 μm and are preferably spaced apart by 1 nm to 200 μm. Further preferably, the ink stripes or spots have a width or diameter of around 100 μm, and are spaced apart by around 100 to 200 μm. These spacings have been found to provide an appropriate optical density to deliver the desired reflectivity. Preferably, the optical density is greater than 0.1.

The metallic nanoparticle ink may be applied by one of several techniques that will be apparent to the person skilled in the art. Preferably, the ink is applied by gravure, however may also be applied by other suitable techniques such as flexography or offset printing.

1. An optical security device, including a substrate having a first surface and a second surface; and a metallic nanoparticle ink provided intermittently in at least one area on the first surface to produce a reflective or partially reflective patch or patches; wherein a high refractive index coating is applied over the area or areas in which the metallic nanoparticle ink is provided, the high refractive index coating adhering to the first surface where the metallic nanoparticle ink is not present, thereby retaining the metallic nanoparticle ink between the first surface and the high refractive index coating.

2. The optical security device according to claim 1, wherein the reflective or partially reflective patch or patches at least partly overlies a relief structure, the relief structure being provided on the first or second surface of the substrate.

3. The optical security device according to claim 2, wherein the relief structure is provided on the first surface of the substrate.

4. The optical security device according to claim 2, wherein the relief structure is provided on the second surface of the substrate.

5. The optical security device according to any one of claims 2 to 4, wherein a translucent or transparent coating is applied directly to at least part of the or each relief structure where the reflective or partially reflective patch or patches are not present.

6. The optical security device according to claim 5, wherein the refractive index of the transparent or translucent coating is substantially the same as the refractive index of the or each relief structure.

7. The optical security device of claim 5 or claim 6, wherein the high refractive index coating and the transparent or translucent coating have the same refractive index.

8. The optical security device according to any one of claims 2 to 7, wherein the relief structure is a diffractive structure.

9. The optical security device according to any one of claims 2 to 8, wherein the relief structure is a diffractive optical element.

10. The optical security device according to any one of claims 1 to 9, wherein the metallic nanoparticle ink is provided in a plurality of substantially parallel lines on the first surface.

11. The optical security device according to claim 10, wherein each line has a width of 1 nm to 200 μm.

12. The optical security device according to claim 10 or claim 11, wherein the lines are spaced apart by 1 nm to 200 μm.

13. The optical security device according to any one of claims 1 to 9, wherein the metallic nanoparticle ink is provided in a plurality of substantially circular spots.

14. The optical security device according to claim 13, wherein each substantially circular spot has a diameter of 1 nm to 200 μm.

15. The optical security device according to claim 13 or claim 14, wherein the spots are spaced apart by 1 nm to 200 μm.

16. The optical security device according to claim 10 or claim 13, wherein the size and spacing of the substantially parallel lines or substantially circular spots produces an optical density of greater than 0.1.

17. The optical security device according to any one of claims 1 to 16, wherein the metallic nanoparticle ink forms a substantially opaque, reflective layer.

18. The optical security device according to any one of claims 1 to 16, wherein the metallic nanoparticle ink forms a semitransparent layer with a refractive index greater than that of the relief structure.

19. The optical security device according to any one of claims 1 to 18, wherein the high refractive index coating is a curable coating.

20. The optical security device according to any one of claims 1 to 19, wherein the metallic nanoparticle ink is a silver nanoparticle ink.

21. The optical security device according to claim 20, wherein the silver nanoparticle ink has less than 40% silver.

22. The optical security device according to any one of claims 1 to 21, wherein the metallic nanoparticle ink is an aluminium nanoparticle ink.

23. The optical security device according to any one of claims 1 to 21, wherein the metallic nanoparticle ink is a titanium nanoparticle ink.

24. The optical security device according to any one of claims 1 to 23 wherein the substrate is transparent or translucent.

25. The optical security device according to any one of the preceding claims wherein the optical security device includes at least one opacifying layer applied to at least part of the first surface of the transparent or translucent substrate.

26. The optical security device according to any one of the preceding claims wherein the optical security device includes at least one opacifying layer applied to at least part of the second surface of the transparent or translucent substrate.

27. The optical security device according to claim 25 or claim 26 wherein the at least one opacifying layer is at least partly omitted to form a window or half window on at least one of the first and second surface of the substrate in the area where the metallic nanoparticle ink and high refractive index coating are provided.

28. The optical security device according to any one of claims 25 to 27 wherein the at least one of the opacifying layers is provided intermittently to the second surface of the substrate in the region of the metallic nanoparticle ink to form indicia or an image.

29. The optical security device of any one of claims 25 to 28 wherein the at least one opacifying layer is an opacifying coating, preferably an opacifying ink layer.

30. A method of manufacturing an optical security device, including applying a metallic nanoparticle ink intermittently in at least one area on a first surface of a substrate, and applying a high refractive index coating over the or each area in which the metallic nanoparticle ink has been applied, whereby the high refractive index coating adheres to the first surface where the metallic nanoparticle ink is not present, thereby retaining the metallic nanoparticle ink between the first surface and the high refractive index coating.

31. A method according to claim 30, further including the step of applying the reflective or partially reflective patch or patches to at least partly overly a relief structure, the relief structure being provided on the first or second surface of the substrate.

32. A method according to claim 30 or claim 31, further including the step of applying the relief structure on the first surface of the substrate.

33. A method according to any one of claims 30 to 32, further including the step of applying the relief structure on the second surface of the substrate.

34. A method according to any one of claims 31 to 33, including the step of applying a transparent or translucent coating directly to at least part of the or each relief structure where the reflective or partially reflective patch or patches are not present.

35. A method according to claim 34 wherein the refractive index of the transparent or translucent coating is substantially the same as the refractive index of the or each relief structure.

36. A method according to claim 35, wherein the high refractive index coating and the transparent or translucent coating are applied as the same coating.

37. A method according to any one of claims 30 to 36, further including the step of applying the relief structure as a diffractive structure.

38. A method according to any one of claims 30 to 37, further including the step of applying the relief structure as a diffractive optical element.

39. A method according to any one of claims 30 to 38, further including the step of applying the metallic nanoparticle ink in a plurality of substantially parallel lines on the first surface.

40. A method according to claim 39, wherein each line is applied with a width of 1 nm to 200 μm.

41. A method according to claim 39 or claim 40, wherein the lines are spaced apart by 1 nm to 200 μm.

42. A method according to any one of claims 30 to 41, wherein the metallic nanoparticle ink are applied in a plurality of substantially circular spots.

43. A method according to claim 42, wherein each substantially circular spot has a diameter of 1 nm to 200 μm.

44. A method according to claim 42 or claim 43, wherein the spots are spaced apart by 1 nm to 200 μm.

45. A method according to claim 39 or claim 42, wherein the size and spacing of the substantially parallel lines or substantially circular spots produces an optical density of greater than 0.1.

46. A method according to any one of claims 30 to 45, wherein the metallic nanoparticle ink is applied as a substantially opaque, reflective layer.

47. A method according to any one of claims 30 to 45, wherein the metallic nanoparticle ink is applied as a semitransparent layer with a refractive index greater than that of the relief structure.

48. A method according to any one of claims 30 to 47, wherein the high refractive index coating is a curable coating.

49. A method according to any one of claims 30 to 48, wherein the metallic nanoparticle ink is a silver nanoparticle ink.

50. A method according to claim 49, wherein the silver nanoparticle ink has less than 40% silver.

51. A method according to any one of claims 30 to 50, wherein the metallic nanoparticle ink is an aluminium nanoparticle ink.

52. A method according to any one of claims 30 to 51, wherein the metallic nanoparticle ink is a titanium nanoparticle ink.

53. A method according to any one of claims 30 to 52 wherein the substrate is transparent or translucent.

54. A method according to any one of claims 30 to 53 wherein the optical security device includes at least one opacifying layer applied to at least part of the first surface of the transparent or translucent substrate.

55. A method according to any one of claims 30 to 54 wherein the optical security device includes at least one opacifying layer applied to at least part of the second surface of the transparent or translucent substrate.

56. A method according to claim 54 or claim 55 wherein the at least one opacifying layer is at least partly omitted to form a window or half window in the area where the metallic nanoparticle ink and high retraction index coating are provided.

57. A method according to any one of claims 54 to 56 wherein the least one opacifying layers is provided intermittently to the second surface of the substrate in the region of the metallic nanoparticle ink to form indicia or an image.

58. A method according to any one of claims 54 to 57 wherein the at least one opacifying layer is an opacifying coating, preferably an opacifying ink layer.

59. An optical security device as manufactured by any one of the methods of claims 30 to 58.

60. A security document, such as a banknote including an optical security device of any one of claim 1 to 29 or 59.
